(19) United States
(12) Patent Application Publication
(10) Pub. No.: US 2025/0287473 A1
(43) Pub. Date: Sep. 11, 2025

(54) INDUCTION HEATING DEVICE, SYSTEM, PRODUCTION LINE, METHOD AND USE

(71) Applicant: SMS Group GMBH, Mönchengladbach (DE)

(72) Inventors: Wolfgang Lenz, Aachen (DE); Thomas Daube, Duisburg (DE); Markus Langejuergen, Wipperfuerth (DE); Ingo Schuster, Willich (DE); Christian Vogt, Wuppertal (DE)

(21) Appl. No.: 18/855,300

(22) PCT Filed: Dec. 1, 2023
(86) PCT No.: PCT/EP2023/083960

§ 371 Date: Oct. 8, 2024

(30) Foreign Application Priority Data
Dec. 2, 2022 (DE) 10 2022 132 027.8

(51) Int. Cl. H05B 6/10; H05B 6/04; H05B 6/06; H05B 6/44

(52) U.S. Cl. CPC H05B 6/101; H05B 6/04; H05B 6/06; H05B 6/44

(57) ABSTRACT

The invention relates to an induction heating device for heating a metallic material, said induction heating device comprising: a number of at least two resonant circuits each for generating a magnetic field for heating the metallic material; and a power supply device for supplying the resonant circuits with electrical power, the power supply device comprising an isolator switch for connecting the induction heating device to an electrical power supply, and at least one inverter for converting a direct current into an alternating current for supplying power to a resonant circuit, the power supply device comprising a switching device, the switching device being designed to enable at least indirect energy coupling between the isolator switch and the resonant circuits, and the number of resonant circuits capable of being simultaneously coupled with energy being smaller than the number of resonant circuits in the induction heating device.

The invention relates to an induction heating device, a system, a production line, a method and a use.

Production lines for producing and/or processing semi-finished products, and/or preliminary products, and/or intermediate products, and/or products made of iron, steel and/or non-ferrous metal materials consist of a plurality of devices in which the preliminary product, and/or the intermediate product, and/or the product are each subjected to one or more method steps. The devices can be, for example, heating or cooling devices, transport devices, shaping devices, cleaning devices, chemical treatment devices, surface coating devices, separating or joining devices and combinations thereof. The method steps can be, for example, increasing temperature or reducing temperature, transportation, forming, cleaning, chemical treatment, surface coating, separating or joining, as well as combinations thereof.

Increasing the temperature of the preliminary product, and/or the intermediate product, and/or the product is required for many method steps and represents an essential method step. Among others, induction heating devices can be used for this purpose. These induction heating devices can be used at various points within the production line.

Induction heating using an induction heating device excites an inductor to vibrate, particularly in the medium-frequency range. It is known to integrate this inductor into a so-called resonant circuit by means of an additional capacitor, which circuit is excited by an inverter, for example by injecting voltage pulses in the vicinity of the resonance frequency of the resonant circuit by means of a bridge circuit, half-bridge circuit or by means of a single switch.

Usually, a mains voltage, for example a single-phase or multi-phase alternating voltage, is first rectified and smoothed, and the direct voltage is fed to an inverter which excites the inductor.

The object of the invention is that of providing an improvement over or an alternative to the prior art.

According to a first aspect of the invention, the object is achieved by an induction heating device for heating a metallic material, in particular a semi-finished product, and/or a preliminary product, and/or an intermediate product, and/or a product made of iron, steel and/or a non-ferrous metal material, comprising:
at least two resonant circuits, in particular three, four, five, six or more resonant circuits, for generating a magnetic field for heating the metallic material each time, and
a power supply device for supplying the resonant circuits with electrical power, comprising:
an isolator switch for connecting the induction heating device to an electrical power supply, and
at least one inverter, in particular two, three, four, five, six or more inverters, for converting a direct current into an alternating current for supplying power to a resonant circuit,
wherein the power supply device has a switching device, wherein the switching device is designed to enable an at least indirect energetic coupling between the isolator switch and the resonant circuits, wherein the number of resonant circuits capable of being simultaneously coupled with energy is smaller than the number of resonant circuits of the induction heating device.

In this regard, the following is explained conceptually: It is first expressly noted that in the context of the present patent application, indefinite articles and numbers such as “one,” “two,” etc. should generally be understood as being “at least” statements, i.e. as “at least one . . . ,” “at least two . . . ,” etc., unless it is clear from the relevant context or it is obvious or technically compelling to a person skilled in the art that only “exactly one . . . ,” “exactly two . . . ,” etc., can be meant.

In the context of the present patent application, the expression “in particular” should always be understood as introducing an optional, preferred feature. The expression should not be understood to mean “specifically” or “namely.”

An “induction heating device” is understood to mean a device which is designed for inductively heating a metallic material using electrical energy. The induction device uses at least one “resonant circuit” having at least one coil to generate an alternating magnetic field created by the coil. If the metallic material is operatively connected to the alternating magnetic field, the alternating magnetic field induces an electrical voltage in the metallic material, which leads to an electrical current in the metallic material, in particular an alternating electrical current. This current always runs in closed paths, can therefore also be called eddy current, and causes the metallic material to heat up according to Joule's losses. In the case of a ferromagnetic metallic material, heating also occurs as a result of remagnitization losses until the Curie temperature is reached, and once it is reached, ferromagnetic or ferroelectric properties of the metallic material have completely disappeared.

Advantageously by means of an induction heating device, direct heating of the metallic material can be achieved since the heat is generated in the metallic material itself and does not have to be introduced from the outside via the surface of the metallic material by heat conduction, convection and/or radiation.

A “metallic material” means any product comprising an electrically conductive ferrous material, a steel material and/or a non-ferrous metal material. In particular, a metallic material can be understood to mean any semi-finished product, and/or any preliminary product, and/or any intermediate product, and/or any product that is electrically conductive.

A coil of an induction heating device can have less than one complete turn, one complete turn, and/or more than one complete turn, in particular more than or exactly two turns, more than or exactly three turns, or more than or exactly four turns.

An operative connection between a metallic material and an alternating magnetic field can be established by longitudinal field induction and/or by transverse field induction. In longitudinal field induction, the magnetic field lines run substantially in the longitudinal direction of extension of the metallic material. In transverse field induction, the magnetic field lines in the metallic material run substantially in a transverse direction of extension of the metallic material, in particular in the thickness direction and/or in the width direction of the metallic material. In transverse field induction, if the metallic material is a metal sheet, the magnetic field lines can enter the metal sheet substantially in the direction of the sheet's thickness and exit the metal sheet in the thickness direction.

A “power supply device” is understood to mean a device that is designed to provide electrical power for operating at least one resonant circuit, in particular with electrical current having a suitable current strength, suitable voltage and/or suitable frequency. A power supply apparatus can be designed to provide electrical power for a plurality of resonant circuits, in particular for at least two resonant circuits, or three, four, five, six or more resonant circuits.

A power supply apparatus can be designed to prepare and provide electrical power to be provided to the resonant circuit for a resonant circuit to operate with optimum efficiency, in particular with the optimal frequency and/or optimal phase position with respect to the phase position of the resonant circuit.

A power supply apparatus can be designed to prevent or reduce any retroactive effects on an electrical power supply that arise from the operation of a resonant circuit.

A power supply apparatus is designed for connection to an electrical power supply. An electrical power supply can be understood to mean a three-phase power. An electrical power supply can be an AC supply or a DC supply.

A power supply can have medium voltage or high voltage.

High voltage can be greater than or equal to 36 kV, preferably greater than or equal to 60 kV and particularly preferably greater than or equal to 100 kV. Furthermore, high voltage can be greater than or equal to 150 kV, preferably greater than or equal to 200 kV, and particularly preferably greater than or equal to 300 kV. High voltage can be less than or equal to 400 kV. Furthermore, high voltage can be less than or equal to 300 kV, preferably less than or equal to 200 kV, and particularly preferably less than or equal to 150 kV.

Medium voltage can be greater than or equal to 1 kV alternating current or greater than or equal to 1.5 kV direct current, preferably greater than or equal to 2 kV, and particularly preferably greater than or equal to 10 kV. Medium voltage can be greater than or equal to 15 kV, preferably greater than or equal to 20 kV, and particularly preferably greater than or equal to 30 kV. Medium voltage can be less than or equal to 36 kV. Furthermore, medium voltage can be less than or equal to 30 kV, preferably less than or equal to 20 kV, and particularly preferably less than or equal to 15 kV.

Preferably, the voltage levels can be defined according to IEC 60519-4.

An “isolator switch” is a switching element that is designed to close or de-energize a circuit, in particular for service and/or maintenance work or interruptions to operation. An isolator switch can be designed as a circuit breaker for high currents.

Optionally, the power supply apparatus comprises a single-phase isolator switch or a three-phase isolator switch.

The isolator switches proposed here can be used to ensure that the power supply apparatus can be de-energized.

Preferably, an isolator switch connects the power supply apparatus to the ground potential in the open position. This can increase safety against electric shocks.

An “inverter” is a power electronic appliance or electrical circuit that is designed to convert a direct current (DC) into an alternating current (AC). The resulting AC frequency depends on the switching algorithm of the inverter.

An inverter circuit can be controlled by applying a pulse-width modulation algorithm.

In particular, the inverter can be designed for operating a specific resonant circuit. When using different resonant circuits, it is also advantageously possible to use different inverters that are specifically adapted to the different resonant circuits, wherein a rectifier, and/or a smoothing circuit, and/or a transformer, and/or an isolator switch can have the same design for a plurality of different resonant circuits.

A “switching device” is understood to mean an assembly which is designed to switch an electrically conductive connection by means of a switch, i.e. to establish or break an electrically conductive connection between at least two contacts.

A switching device can be designed to switch an alternating current. The switching device can be accordingly arranged between an inverter and at least one resonant circuit.

A switching device can be designed to switch a direct current. The switching device can accordingly be arranged between a rectifier or a smoothing circuit or a direct current supply and at least one resonant circuit.

Preferably, a switching device has a plurality of switching options between a power source, preferably an alternating current source or a direct current source, and at least two consumers, preferably three, four, five or more consumers, in particular resonant circuits and/or inverters. The switching device can be designed to disconnect or establish precisely one connection between a power source and precisely one of the consumers or to switch to another consumer. The switching device can be designed to disconnect or establish or change two, three, four or more connections between exactly one power source and two, three, four or more of the consumers, in particular to change them in pairs.

A switching device can be designed to comprise a plurality of power sources, wherein each power source can be connected to or disconnected from or switched to precisely one consumer or a plurality of consumers. Preferably, the switching device is designed such that less than one connection can be established between a consumer and at least two power sources at the same time.

In this case, a power supply device for an induction heating device is proposed, comprising an isolator switch, at least two inverters and a switching device, wherein the isolator switch is designed to connect the power supply device to an electrical power supply, wherein an inverter is designed to convert a direct current into an alternating current for supplying power to a resonant circuit, wherein the switching device is designed to enable at least an indirect energetic coupling between the isolator switch and a plurality of resonant circuits, and wherein the number of resonant circuits that can be simultaneously energetically coupled is smaller than the number of resonant circuits that can be connected to the switching device, at least indirectly.

By means of the power supply apparatus, at least one component of the power supply apparatus can be used alternately and/or intermittently for a plurality of resonant circuits, wherein the majority of the resonant circuits cannot be operated simultaneously. In other words, certain components of the power supply device, in particular the isolator switch, are only installed as often as they are required for the reasonable simultaneous operation of the installed/installable resonant circuits, while the resonant circuits can be installed at any position in a production line where heating may be required.

Alternatively, an induction heating device is proposed here which has an above-described power supply device and at least two resonant circuits.

In this way, different resonant circuits at different points in a production line can be operated alternately and/or intermittently with a common component of the power supply device which is only designed to operate some or one of the available resonant circuits.

Energy supply devices account for a large proportion of the investment costs of an induction heating device. With the power supply device proposed here, the investment costs of an induction heating device can be reduced, in particular for an induction heating device with spatially distributed resonant circuits.

Often, not all resonant circuits in a production line are operated simultaneously. Resonant circuits are currently predominantly operated depending on the product currently to be manufactured. It is possible that a total of six resonant circuits are installed within a production line, but only a maximum of three resonant circuits can be operated at the same time in each case. If each induction heating device were to contain all the components of a power supply device, the full investment costs associated therewith would be incurred.

Modern production lines must generally be able to respond flexibly to a wide range of metallic materials to be produced, each with its own requirements for temperature control during the method steps to be carried out. The most economical way of operating the production line may require the use of resonant circuits at different positions within the production line, depending on the product, the products produced before and after, the current energy price mix and other boundary conditions.

The power supply device proposed here can improve the flexibility of the production line, reduce response time during product changeover, improve the energy efficiency of the production line for operating modes or metallic materials that allow this, and shorten the structural length of a production line.

Optionally, the isolator switch is designed to connect the induction heating device to a direct current supply.

Here, it is proposed that the isolator switch of the power supply device is designed to be connected to a direct current supply, preferably to a direct current supply having a medium voltage or a low voltage.

The inverters of the power supply device can be designed such that they can be indirectly connected to the direct current supply, therefore preferably being suppliable with a medium-voltage direct voltage or a low-voltage direct voltage.

Low voltage can be greater than or equal to 120 V, preferably greater than or equal to 220 V, and particularly preferably greater than or equal to 240 V. Low voltage can be less than or equal to 1,000 V, and particularly preferably less than or equal to 900 V. Low voltage can be less than or equal to 600 V, preferably less than or equal to 240 V and particularly preferably less than or equal to 220 V.

Optionally, the isolator switch is configured to connect the induction heating device to an alternating current supply, wherein the power supply device has at least one rectifier, in particular two, three, four, five, six or more rectifiers, between the isolator switch and the at least one inverter for converting an alternating current into a direct current for supplying power to the at least one inverter.

In this regard, the following is explained conceptually:
A “rectifier” is an electrical appliance that converts alternating current, which periodically changes direction, into direct current.

A rectifier can be a three-phase rectifier. The rectifier can be designed to be supplied with a medium voltage or a low voltage.

A rectifier can have a topology that includes diodes and/or consists of diodes. A three-phase rectifier can be an uncontrolled n×6-pulse diode rectifier, in particular a 6-pulse diode rectifier, a 12-pulse diode rectifier, an 18-pulse diode rectifier, and so on.

By using transistors and/or thyristors, a rectifier can be advantageously controlled or regulated. As a consequence, the power supply device must be connected to a static reactive power compensator in order to comply with specifications of a power company.

The power supply device expediently has a transformer between the isolator switch and the at least one rectifier.

In this regard, the following is explained conceptually:
A “transformer” is a component that transfers electrical energy from one circuit to another circuit without a conductive connection existing between the two circuits. The transformer converts an alternating current (AC) in a primary side of the transformer into an alternating current in a secondary side of the transformer.

A transformer can be a three-phase transformer.

The transformer can be a high voltage-to-medium voltage transformer that converts a high voltage in a primary side of the transformer into a medium voltage in a secondary side of the transformer.

The transformer can be a high voltage-to-low voltage transformer that converts a high voltage in a primary side of the transformer into a low voltage in a secondary side of the transformer.

The transformer can be a medium voltage-to-low voltage transformer that converts a medium voltage in a primary side of the transformer into a low voltage in a secondary side of the transformer.

Optionally, the isolator switch is designed as a medium-voltage switchgear.

In this regard, the following is explained conceptually:
A “medium-voltage switchgear” is understood to mean a central arrangement of circuit breakers, and/or fuses, and/or protective switches which serve to protect, and/or control, and/or earth the power supply device.

According to a preferred embodiment, the at least one inverter and/or the at least one rectifier is/are designed for medium-voltage operation. In other words, the at least one rectifier and/or the at least one inverter is/are designed to be supplied with a medium voltage.

Preferably, the power supply device has a smoothing circuit between the isolator switch and the at least one inverter, in particular between the at least one rectifier and the at least one inverter.

In this regard, the following is explained conceptually:
Deriving a direct voltage from an alternating current source within a power supply, in particular within a power supply apparatus, can lead to a ripple voltage, in particular when using a diode rectifier. The ripple voltage is a residual periodic fluctuation in the output voltage of a rectifier.

To smooth the ripple voltage, a rectifier can be connected to a “smoothing circuit” which is designed to smooth the ripple voltage.

The smoothing circuit can comprise a capacitor connected in parallel with a rectifier circuit.

The smoothing circuit can include an inductor that is connected in series with a rectifier circuit.

According to an expedient embodiment, a rectifier and an inverter can be energetically coupled to one another using DC busbars.

According to an optional embodiment, the power supply device has a DC-to-DC converter between the isolator switch and the at least one inverter, in particular between the at least one rectifier and the at least one inverter.

In this regard, the following is explained conceptually:
A “DC-to-DC converter” is a power electronic appliance or an electrical circuit that is designed to convert a direct current (DC) applied at the input of the DC-to-DC converter and has a voltage that is supplied at the input, into a direct current at the output of the DC-to-DC converter having a higher, lower or inverted voltage level.

A DC-DC converter, arranged between a rectifier and an inverter, enables a change in the voltage level between the rectifier and the inverter. In this way, in particular, a medium-voltage rectifier can be combined with a low-voltage inverter. This can improve the overall efficiency of the power supply apparatus.

Preferably, a switching device is arranged between a rectifier and at least two inverters, wherein the switching device is designed to:
establish an energy coupling between the rectifier and precisely one inverter, and/or
establish an energy coupling between the rectifier and a group of inverters, in particular an energy coupling between the rectifier and a subset of the group of inverters.

Alternatively, in the case of an induction heating device already supplied with direct voltage and which can be connected, inter alia, to a local direct voltage transmission network, a switching device can be arranged between the isolator switch and at least two inverters, wherein the switching device is designed to
energetically couple the isolator switch and precisely one inverter, and/or
energetically couple the isolator switch and a group of inverters, in particular energetically couple the isolator switch and a subset of the group of inverters.

The switching device proposed here is arranged between a rectifier or an isolator switch and at least two inverters such that the switching device is designed to switch in the region of direct current transmission line.

This advantageously makes it possible for the components of the power supply device installed between the electrical power supply of the induction heating device and the switching device not to have to be designed separately for each resonant circuit supplied with power. Rather, it is sufficient if the only one of the components installed upstream of the switching device is installed, whereby each of the components only need to be adapted to the maximum designated electrical power provided by the induction heating device at one time. Since at least one less resonant circuit of the induction heating device than the total number of resonant circuits arranged in the induction heating device can be operated in this case, the nominal power of the components as far as the switching device can also accordingly be smaller and be less than the sum of the nominal powers of all the resonant circuits installed, in particular the nominal power of the isolator switch and/or the transformer and/or the rectifier. Alternatively, the rated electrical power that can be provided by the power supply device can also be provided by a plurality of individual components, in particular components connected in parallel with one another. For example, among others, a plurality of transformers and/or a plurality of rectifiers can be connected in parallel upstream of the switching device without departing from the aspect proposed here. The components connected in parallel can be designed in such a way that they can each provide some of the required rated electrical power.

Thus, the induction heating device can have at least one less rectifier and/or one transformer and/or one isolator switch less than resonant circuits.

With regard to the possible switching states of the switching device proposed here, the switching device can be designed in such a way that up to precisely one resonant circuit of the plurality of resonant circuits connected to the individual switching device can be simultaneously energetically coupled to the direct current connection of the switching device. The majority of the resonant circuits connected to the switching device can accordingly be operated alternately and/or intermittently.

Alternatively, with regard to the possible switching states of the switching device proposed here, the switching device can be designed in such a way that an energy coupling can be established between the direct current connection of the switching device and a group of inverters, in particular an energy coupling between the direct current connection of the switching device and a subset of the group of inverters, it also being provided here that at least one less resonant circuit than the total number of installed resonant circuits can be operated at one time. In this case, it can be provided that one switching connection can be changed alternately or intermittently in each case, or a plurality of switching connections can simultaneously be changed alternately and/or intermittently; in particular, it can thus also be provided that a pair of resonant circuits can be switched simultaneously, in particular a first pair of resonant circuits can be changed at the same time as a second pair of resonant circuits.

For example, inter alia, a first pair of resonant circuits arranged in a front region of a production line can be operated alternately or intermittently with respect to a second pair of resonant circuits that is arranged in a rear region of the production line.

A switching device is expediently arranged between an inverter and at least two resonant circuits, wherein the switching device is designed to:
establish an energy coupling between the inverter and precisely one resonant circuit for generating a magnetic field, and/or
establish an energy coupling between the inverter and a group of resonant circuits for generating a magnetic field each time, in particular an energy coupling between the inverter and a subset of the group of resonant circuits.

The switching device proposed here is arranged between an inverter and at least two resonant circuits such that the switching device is designed to switch in the region of the alternating current transmission line.

This advantageously makes it possible for the components of the power supply device to not have to be separately designed for each supplied resonant circuit. Rather, they can each be dimensioned once and/or be according to the maximum nominal power that can be requested at one time by the resonant circuits, wherein parallel connections of individual components are also conceivable in order to achieve the necessary nominal power.

Thus, the induction heating device can have at least one rectifier, and/or one inverter, and/or one transformer, and/or one isolator switch less than the number of resonant circuits. Furthermore, the induction heating device can be dimensioned with regard to the nominal power that can be provided by the power supply device such that this is smaller than the sum of the nominal powers of the resonant circuits comprised by the induction heating device.

It goes without saying that an induction heating device can also have a plurality of switching devices.

Thus, it can be provided, inter alia, that the induction heating device can have at least two switching devices between at least one isolator switch and a plurality of at least indirectly connected inverters, wherein the plurality of switching devices can also be connected in parallel with one another and can be connected to precisely one isolator switch and/or precisely one transformer and/or precisely one rectifier.

It can also be provided that the induction heating device can have at least two switching devices between at least one inverter and a plurality of at least indirectly connected resonant circuits preferably with the same electrical properties, wherein the plurality of switching devices can also be connected in parallel with one another and can be connected to precisely one inverter and/or precisely one transformer and/or precisely one rectifier.

Furthermore, it can be provided that the induction heating device can have one or more switching devices between at least one isolator switch and at least a plurality of inverters as well as one or more switching devices between at least one inverter and at least a plurality of resonant circuits.

Parallel operation of a plurality of resonant circuits in an inverter is also conceivable, it being advantageous for the plurality of resonant circuits to have the same electrical properties.

Preferably, the induction heating device is designed to be mechanically movable and/or at least partially mechanically movable.

In this regard, the following is explained conceptually:
“Mechanically movable” is understood to mean that the unit in question, in particular the induction heating device or the power supply device, is detachably connected to the designated surface on which it is placed, the unit comprises lifting tackle for fastening the unit to a crane or the like, and/or the unit is supplied with electricity and/or operating materials, in particular coolant, by means of detachable connecting means.

The induction heating device can thereby be used flexibly at different positions in a production line, wherein the time for retrofitting the production line can be minimized. The lifting tackle enables the induction heating device to be moved as required by a crane, an industrial truck and/or a different dedicated moving apparatus.

According to an advantageous embodiment, a single resonant circuit can be designed to be movable so that it can be used alternately at different positions on a production line.

According to an expedient embodiment, the power supply device is designed to be mechanically movable and/or at least partially mechanically movable.

Part of a power supply device can in particular be a component of a power electronic system of a power supply device, in particular a transformer, a rectifier, a DC-to-DC converter, an inverter and/or a smoothing circuit.

Optionally, a resonant circuit is designed for longitudinal field induction and/or transverse field induction.

In this regard, the following is explained conceptually:
A resonant circuit designed for “longitudinal field induction” can have a coil which encloses at least one edge of the metallic material, preferably at least two edges and particularly preferably four edges.

Preferably, a resonant circuit designed for longitudinal field induction comprises a plurality of turns of the coil wound transversely to the designated longitudinal extension of the metallic material, preferably at least two turns, preferably at least three turns and particularly preferably at least four turns, wherein the plurality of turns are preferably compactly arranged next to one another, the shortest distance between two adjacent turns preferably being smaller than a transverse extension of a turn.

A resonant circuit designed for “transverse field induction” has a coil which extends predominantly in one plane, preferably extends meanderingly in one plane, wherein the coil preferably does not enclose any edges of the metallic material.

Preferably, a resonant circuit designed for “transverse field induction” has a first coil and a second coil which each extend predominantly in one plane, preferably extend meanderingly in one plane, wherein the coils each preferably do not enclose any edges of the metallic material. The respective extension planes can be parallel to one another. The respective coils can be arranged mirror-symmetrically to one another. Preferably, the metallic material to be heated is passed between the coils, preferably in the mirror plane.

A coil arrangement designed in this way consisting of a first coil extending substantially in one plane and a second coil extending mirror-symmetrically thereto, can also be used for longitudinal field induction if each coil forms a separate resonant circuit, and the resonant circuits are operated with opposite timing, i.e. have a phase angle of the relevant operating currents of preferably 180 degrees.

Advantageously, a resonant circuit designed for transverse field induction and a resonant circuit designed for longitudinal field induction can be operated on a power supply device that is at least partially the same, which allows investment costs of a production line to be reduced. In particular, the isolator switch, the rectifier and the smoothing circuit can equally be used for a resonant circuit designed for transverse field induction and a resonant circuit designed for longitudinal field induction, without being modified. In principle, the inverter of the power supply device can also be the same, wherein a different operating mode can be selected if necessary and/or a different open-loop control and/or closed-loop control signal can be used for the inverter, in particular a different pulse-width modulation signal.

An electrical connection between an inverter and a resonant circuit is expediently formed by means of a fluid-cooled busbar, in particular a busbar designed to be internally cooled by a fluid.

Preferably, a busbar between an inverter and a resonant circuit can be cooled by a liquid coolant, in particular water, wherein the coolant can preferably be guided within the busbar and further preferably by the busbar. In this way, a busbar can be cooled, among other things, by means of forced convection.

Alternatively, a busbar can be cooled by a gaseous coolant, in particular air or a different gas mixture. This allows the busbar to be cooled by both forced convection and/or free convection.

According to a second aspect of the invention, the object is achieved by a system comprising a plurality of induction heating devices according to the first aspect of the invention.

It goes without saying that the above-described advantages of an induction heating device according to the first aspect of the invention are directly transferable to a system comprising a plurality of induction heating devices according to the first aspect of the invention.

It should be expressly noted that the subject matter of the second aspect can advantageously be combined with the subject matter of the preceding aspect of the invention, both individually or cumulatively in any combination.

According to a third aspect of the invention, the object is achieved by a production line for producing and/or processing a metallic material, in particular a semi-finished product, and/or a preliminary product, and/or an intermediate product, and/or a product made of iron, steel and/or a non-ferrous metal material, comprising an induction heating device according to the first aspect of the invention, and/or a system according to the second aspect of the invention.

It goes without saying that the above-described advantages of an induction heating device according to the first aspect of the invention and/or a system according to the second aspect of the invention can be directly transferred to a production line for producing and/or processing a metallic material, in particular a semi-finished product, and/or a preliminary product, and/or an intermediate product, and/or a product made of iron, steel and/or a non-ferrous metal material, comprising an induction heating apparatus according to the first aspect of the invention, and/or a system according to the second aspect of the invention.

A production line can be a hot-rolling mill, in particular with a warm or hot insert, and/or a conveyor system.

It should be expressly noted that the subject matter of the third aspect can advantageously be combined with the subject matter of the preceding aspects of the invention, both individually or cumulatively in any combination.

According to a fourth aspect of the invention, the object is achieved by a method for operating an induction heating apparatus according to the first aspect of the invention, wherein at least two resonant circuits are operated alternately and/or intermittently alternately at different locations in a production line.

It goes without saying that the above-described advantages of an induction heating device according to the first aspect of the invention can be directly transferred to a method for operating an induction heating device according to the first aspect of the invention.

It should be expressly noted that the subject matter of the fourth aspect is advantageously combinable with the subject matter of the preceding aspect of the invention, both individually or cumulatively in any combination.

According to a fifth aspect of the invention, the object is achieved by the use of an induction heating device according to the first aspect of the invention for producing and/or processing a metallic material, in particular a semi-finished product, and/or a preliminary product, and/or an intermediate product, and/or a product made of iron, steel and/or a non-ferrous metal material.

It goes without saying that the above-described advantages of an induction heating device according to the first aspect of the invention can be directly transferred to the use of an induction heating device according to the first aspect of the invention.

It should be expressly noted that the subject matter of the fifth aspect is advantageously combinable with the subject matter of the preceding aspect of the invention, both individually or cumulatively in any combination.

Further advantages, details, and features of the invention can be found below in the described embodiments. In the figures, in detail:

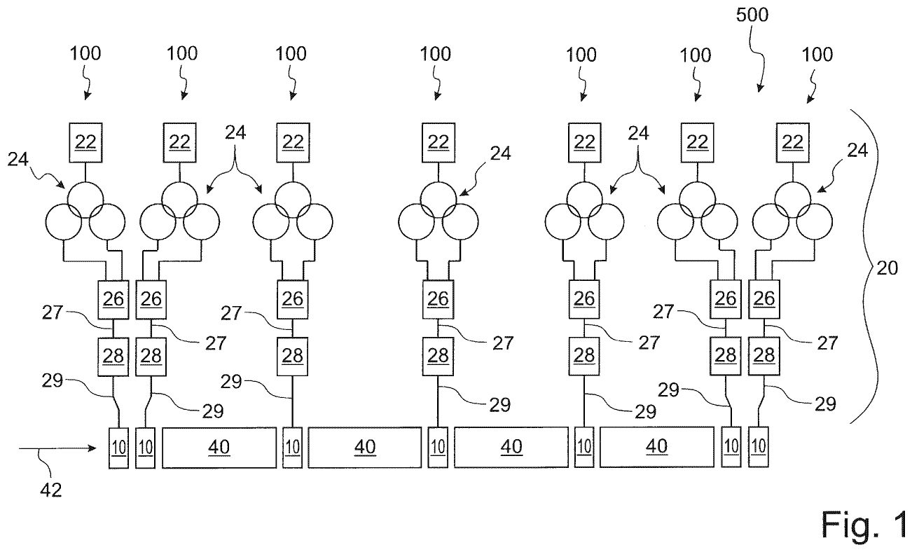

FIG. 1: schematically shows a system comprising a plurality of induction heating devices according to the prior art;

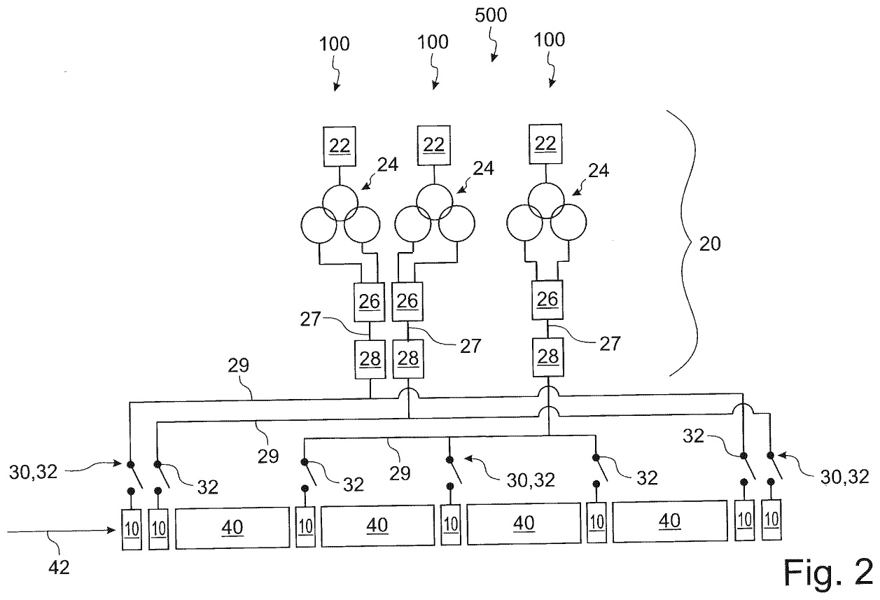

FIG. 2: schematically shows a first embodiment of a system of induction heating devices;

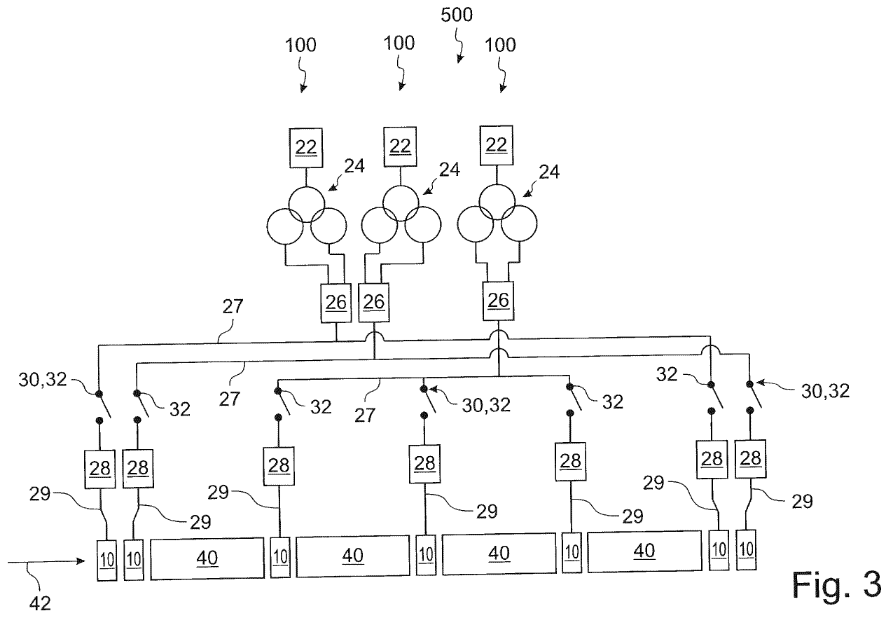

FIG. 3: schematically shows a second embodiment of a system of induction heating devices; and

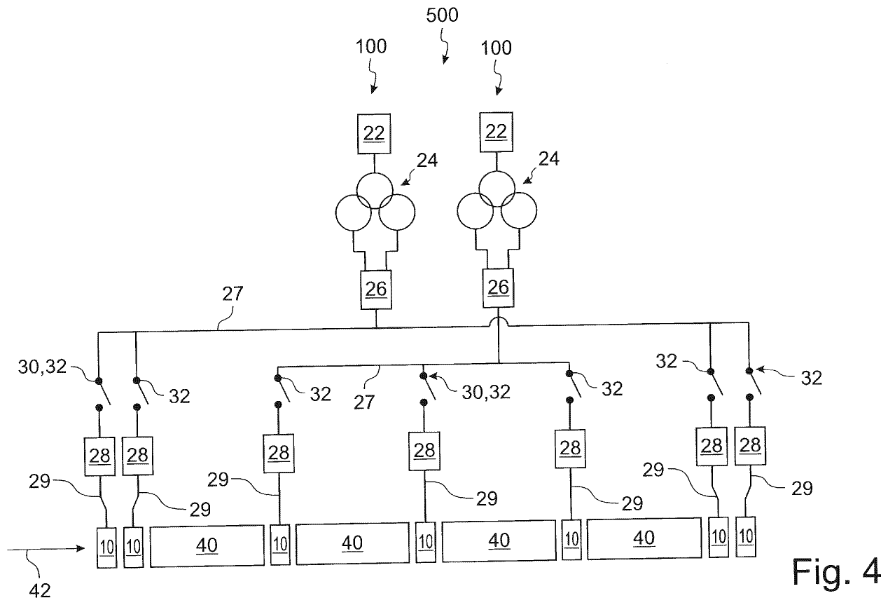

FIG. 4: schematically shows a third embodiment of a system of induction heating devices.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

A system 500 having a plurality of induction heating devices 100, in particular having seven induction heating devices 100, according to the prior art in FIG. 1 for heating a metallic material (not shown) substantially consists of a plurality of independent induction heating devices 100 which have less than one direct operative connection to one another.

In principle, an induction heating device 100 consists of a power supply device 20 and a resonant circuit 10, wherein the power supply device 20 has at least one inverter 28 and an isolator switch 22.

Each induction heating device 100 has at least one isolator switch 22, precisely one inverter 28 and precisely one resonant circuit 10, wherein the resonant circuit 10 is designed to generate a magnetic field for heating the metallic material (not shown) each time.

The isolator switch 22 is configured to connect the induction heating device 100 to an electrical power supply (not shown).

The inverter 28 is designed to convert a direct current into an alternating current in order to supply energy to the resonant circuit 10 and is connected to the resonant circuit 10 by means of alternating current transmission 29.

According to a first variant (not shown), the electrical power supply (not shown) can be a direct current transmission network, in particular a direct current transmission network having a medium voltage. According to this variant, the inverter 28 can be connected to the electrical power supply directly via the isolator switch 22 or indirectly via a DC-to-DC converter (not shown) and the isolator switch 22 by means of direct current transmission 27.

According to a second variant, the electrical power supply can be an alternating current supply, in particular a three-phase alternating current network. In this case, the power supply device 20 has a rectifier 26 which can be connected to the inverter 28 directly by means of direct current transmission 27 and/or by means of a DC-to-DC converter (not shown). Furthermore, the power supply device 20 can comprise a transformer 24. Thus, the electrical power supply (not shown) can be, among other things, a high voltage power supply or a medium voltage power supply, wherein a transformer 24 can be configured to convert the high voltage into a medium voltage or a low voltage, or to convert the medium voltage into a low voltage.

The plurality of induction heating devices 100 in the system 500 can be arranged in a production line (not designated/not shown) for producing/processing a metallic material, in particular a semi-finished product, and/or a preliminary product, and/or an intermediate product, and/or a product made of iron, steel and/or a non-ferrous metal material which, in addition to the induction heating devices 100, can also comprise treatment apparatuses 40 for treating the metallic material (not shown), and wherein the metallic material (not shown) can be conveyed in a preferred direction of movement 42 through the production line (not designated/not shown). Depending on the position and rated power of an induction heating device 100, different positions within the production line (not designated/not shown) are conceivable for each of the resonant circuits 10.

Deviating from this, a system 500 having a plurality of induction heating devices 100, in particular having three induction heating devices 100, has, in FIG. 2, a plurality of switching apparatuses 30, in particular a number of switching devices 30 which corresponds to the number of induction devices 100, in particular three switching devices 30, wherein the system has six resonant circuits 10 for heating a metallic material (not shown).

Accordingly, the system 500 comprising a plurality of induction heating devices 100 also comprises a plurality of power supply devices 20, in particular a number of power supply devices 20 which corresponds to the number of induction devices 100, in particular three power supply devices 20.

According to the embodiment in FIG. 2, the switching apparatuses 30 are each arranged in the region of alternating current transmission 29 of the induction heating device 100.

Each power supply device 20 has at least one isolator switch 22 and at least one inverter 28, wherein each inverter 28 is indirectly connected via a switching device 30 to at least two resonant circuits 10 each time.

Depending on the design of an electrical power supply (not shown), a power supply device 20 can also have a transformer 24 and/or a rectifier 26, wherein a rectifier can be directly connected to an inverter 28 by means of direct current transmission 27 and/or a DC-to-DC converter (not shown).

Each switching device 30 has at least two switches 32 which allow a connected state to be set between an inverter 28 and a resonant circuit 10.

Several production lines (not shown) are installed for different metallic materials (not shown) to be produced and/or processed such that a certain flexibility of the production line in terms of technical equipment, particular the quantity and/or position of induction heating devices 100 is desirable/provided. However, this also increases the investment costs of a production line. The induction heating device 100 proposed here has a switching device 30 within the power supply device 20, by means of which a plurality of resonant circuits can be alternately or intermittently supplied with power and/or operated, or, provided that the resonant circuits 10 are electrically configured the same, can be simultaneously supplied and/or operated by a common power supply device 20. This enables a reduction in the necessary investment costs compared to the prior art.

Accordingly, by means of the induction heating device 100 proposed here, the number of resonant circuits 10 to which electrical energy can be provided alternately and/or intermittently or simultaneously by the power supply device 20 can be greater than the number of power supply devices 20.

In FIG. 3, a system 500 having a plurality of induction heating devices 100, in particular having three induction heating devices 100, also has a plurality of switching apparatuses 30, in particular a number of switching devices 30 that corresponds to the number of induction devices 100, in particular three switching devices 30, wherein the system has seven resonant circuits 10 for heating a metallic material (not shown). In contrast to the embodiment according to FIG. 2, the switching devices 30 are arranged here in the region of direct current transmission 27.

Accordingly, an inverter 28 is connected to each resonant circuit 10 by means of alternating current transmission 29. This advantageously allows each individual resonant circuit 10 to be individually controlled and/or regulated via its individually assigned inverter 28.

Accordingly, the number of resonant circuits 10 to which electrical energy can be provided alternately and/or intermittently or simultaneously by the power supply device 20 and which corresponds to the number of inverters 28 can be greater than the number of rectifiers 26 and the number of isolator switches 22 and/or transformers 24.

In FIG. 4, a system 500 having a plurality of induction heating devices 100, in particular having two induction heating devices 100, also has a plurality of switching devices 30, in particular a number of switching devices 30 that corresponds to the number of induction devices 100, in particular two switching devices 30, wherein the system has seven resonant circuits 10 for heating a metallic material (not shown).

A first induction heating device 100 is designed such that two resonant circuits 10 are arranged at the front end of a production line (not shown) and at the rear end of the production line. Among other things, consideration should be taken of the fact that the resonant circuits 10 mounted at the front end can be alternatingly or intermittently operated in pairs with the resonant circuits 10 mounted at the rear end.

### LIST OF REFERENCE SIGNS

10 Resonant circuit
20 Energy supply device
22 Isolator switch
24 Transformer
26 Rectifier
27 Direct current transmission
28 Inverter
29 Alternating current transmission
30 Switching device
32 switch
40 Treatment apparatus
42 Direction of movement
100 Induction heating device
500 System

1. An induction heating device (100) for heating a metallic material, in particular a semi-finished product, and/or a preliminary product, and/or an intermediate product, and/or a product made of iron, steel and/or a non-ferrous metal material, comprising:
at least two resonant circuits (10) capable of generating a magnetic field for heating the metallic material each time, and
a power supply device (20) for supplying the at least two resonant circuits (10) with electrical power, the power supply device (20) comprising:
an isolator switch (22) for connecting the induction heating device (100) to an electrical power supply;
at least one inverter (28) for converting a direct current into an alternating current for supplying power to at least one of the at least two resonant circuits (10); and
a switching device (30) capable of enabling at least an indirect energetic coupling between the isolator switch (22) and the at least two resonant circuits (10), the number of the at least two resonant circuits (10) that can be simultaneously energetically coupled being smaller than the number of the at least two resonant circuits (10) of the induction heating device (100).

2. The induction heating device (100) according to claim 1, wherein the isolator switch (22) is capable of connecting the induction heating device (100) to a DC supply.

3. The induction heating device (100) according to claim 1, wherein
the isolator switch (22) is capable of connecting the induction heating device (100) to an AC supply, and
the power supply device (20) has at least one rectifier (26) between the isolator switch (22) and the at least one inverter (28), for converting an alternating current into a direct current for supplying power to the at least one inverter (28).

4. The induction heating device (100) according to claim 3, wherein the power supply device (20) comprises a transformer (24) between the isolator switch (22) and the at least one rectifier (26).

5. The induction heating device (100) according to claim 1, wherein the isolator switch (22) is a medium voltage switchgear (36).

6. The induction heating device (100) according to claim 1, wherein the at least one inverter (28) and/or the at least one rectifier (26) is/are designed for medium-voltage operation.

7. The induction heating device (100) according to claim 1, wherein the power supply device (20) has a smoothing circuit between the isolator switch (22) and the at least one inverter (28).

8. The induction heating device (100) according to claim 1, wherein the power supply device (20) has a DC-to-DC converter between the isolator switch (22) and the at least one inverter (28).

9. The induction heating device (100) according to claim 1, wherein a switching device (30) is arranged between a rectifier (26) and at least two inverters (28), the switching device (30) capable of establishing
an energy coupling between the rectifier (26) and exactly one inverter (28), and/or
between the rectifier (26) and a group of inverters (28).

10. The induction heating device (100) according to claim 1, wherein a switching device (30) is arranged between an inverter (28) and at least two resonant circuits (10), the switching device (30) capable of establishing
an energy coupling between the inverter (28) and exactly one resonant circuit (10) to generate a magnetic field, and/or
between the inverter (28) and a group of resonant circuits (10) for generating a magnetic field each time.

11. The induction heating device (100) according to claim 1, wherein the induction heating device (100) is at least partially mechanically movable.

12. The induction heating device (100) according to claim 1, wherein the power supply device (20) is at least partially mechanically movable.

13. The induction heating device (100) according to claim 1, wherein a resonant circuit (10) is capable of longitudinal field induction and/or transverse field induction.

14. The induction heating device (100) according to claim 1, wherein an electrical connection between an inverter (28) and a resonant circuit (10) is formed by means of a fluid-cooled busbar.

15. A system (500) comprising a plurality of induction heating devices (100), each of the plurality of induction heating devices (100) comprising:
at least two resonant circuits (10) capable of generating a magnetic field for heating the metallic material each time; and
a power supply device (20) for supplying the at least two resonant circuits (10) with electrical power, the power supply device (20) comprising:
an isolator switch (22) for connecting the induction heating device (100) to an electrical power supply;
at least one inverter (28) converting a direct current into an alternating current for supplying power to at least one of the at least two resonant circuits (10); and
a switching device (30) capable of enabling at least an indirect energetic coupling between the isolator switch (22) and the at least two resonant circuits (10), the number of the at least two resonant circuits (10) that can be simultaneously energetically coupled being smaller than the number of the at least two resonant circuits (10) of the induction heating device (100).

16. (canceled)

17. A method for operating an induction heating device (100) for heating a metallic material, the method comprising:
using at least two resonant circuits (10) of the induction heating device (100), generating a magnetic field for heating a metallic material each time; and
using a power supply device (20) of the induction heating device (100), supplying the at least two resonant circuits (10) with electrical power, the power supply device (20) comprising an isolator switch (22), at least one inverter (28), and a switching device (30);
using the isolator switch (22), connecting the induction heating device (100) to an electrical power supply:
using the at least one inverter (28) converting a direct current into an alternating current for supplying power to at least one of the at least two resonant circuits (10); and
using the switching device (30), enabling at least an indirect energetic coupling between the isolator switch (22) and the at least two resonant circuits (10), the number of the at least two resonant circuits (10) that can be simultaneously energetically coupled being smaller than the number of the at least two resonant circuits (10) of the induction heating device (100),
wherein the at least two resonant circuits (10) are operated alternately and/or intermittently alternately at different locations in a production line.

18. (canceled)
